(19) United States
(12) Patent Application Publication
(10) Pub. No.: US 2011/0239640 A1
(43) Pub. Date: Oct. 6, 2011

(54) HEAT EXCHANGER STRUCTURE AND ISOTHERMAL COMPRESSION OR EXPANSION CHAMBER

(75) Inventor: Pierre Charlat, Lans en Vercors (FR)

(73) Assignee: Stiral, Corenc (FR)

(21) Appl. No.: 13/122,444

(22) PCT Filed: Oct. 1, 2009
(86) PCT No.: PCT/FR2009/051874

§ 371 Date: Jun. 1, 2011

(30) Foreign Application Priority Data
Oct. 3, 2008 (FR) 0856720

(51) Int. Cl. F02G 1/055

(52) U.S. Cl. 60/517

(57) ABSTRACT

A thermodynamic machine includes at least one chamber in which an isothermal expansion and/or compression is to be carried out, said chamber being longitudinally defined by first and second walls that are mobile relative to each other. The chamber is divided by partitions extending longitudinally from each of the first and second walls, the partitions being interleaved within each other, and the distance between the partitions extending from a same wall being such that the ratio between the distance squared and the cycle duration of the thermodynamic machine is lower than the average thermal diffusivity of the gas contained in the chamber.

### FIELD OF THE INVENTION

The present invention generally relates to a heat exchanger structure. The present invention also relates to a chamber in which isothermal compressions and/or expansions are performed. The present invention further relates to a high-efficiency reversible thermodynamic engine comprising such a chamber, for example, a Stirling engine.

### DISCUSSION OF PRIOR ART

Stirling engines are sometimes used for industrial refrigeration and in military or space applications. Such engines have the advantage of being usable as motors or to generate heat or cold without the use of refrigerants, which are generally polluting. Another advantage of a Stirling engine is that its hot source is external and that this source can thus be obtained by means of any known fuel type, or even solar radiation.

In a Stirling cycle, a gas, for example, air, hydrogen, or helium, is submitted to a four-phase cycle: an isochoric heating, an isothermal expansion, an isochoric cooling, and an isothermal compression.

FIG. 1 is a generic diagram of a Stirling engine. A first chamber 3 is connected to a second chamber 5 via a first heat exchanger 7, a regenerator 9, and a second heat exchanger 11. The assembly comprised of the chambers, the exchangers, and the regenerator may be cylindrical. First and second exchangers 7 and 11 respectively are in contact with a hot source at a hot temperature T_{C} and with a cold source at a cold temperature T_{F}. Chambers 3 and 5 are respectively closed by moving pistons 13 and 15 which define the variable volumes of chambers 3 and 5. It should be understood that there are different ways for the different elements of the Stirling engine shown in FIG. 1 to be mobile with respect to one another: for example, the two pistons 13 and 15 may be mobile and regenerator 9 and exchangers 7 and 11 may be fixed, in the case of a so-called alpha configuration. One of pistons 13 or 15 may also be fixed if the central portion of the engine is mobile. The assembly formed of regenerator 9 and of exchangers 7 and 11 may also be provided to be fixed and the variable volumes of chambers 3 and 5 may be formed of a single variable volume separated in two by a mobile wall, called a displacer. Such a configuration is called beta or gamma configuration.

FIGS. 2A to 2D illustrate steps of a Stirling engine cycle.

In an initial arbitrary state A illustrated in FIG. 2A, a gas volume is stored in first chamber 3, second chamber 5 preferably having a zero or very low volume.

The gas in first chamber 3 is heated by the hot source and its pressure increases. This displaces piston 13 to a state B in which the volume taken up by the gas in chamber 3 is greater than the volume of this same chamber at state A. During the isothermal expansion phase (step A and B), mechanical work is extracted.

An isochoric cooling then enables to pass from state B to a state C in which the gas in hot chamber 3 is transferred into cold chamber 5. During this transfer, the gas stored in chamber 3 passes through regenerator 9 and has cooled down as it reaches chamber 5. The heat contained in the hot gas is “extracted” in the regenerator, as will be seen hereafter, and the gas cools down.

An isothermal compression enables to pass from state C to a state D in which the volume taken up by the gas in chamber 5 is lower than the volume of this same chamber at state C. This compression is performed by actuating piston 15 to decrease the volume of chamber 5. This step consumes power, but less than the power provided between states A and B.

Finally, an isochoric transfer enables to pass from state D to initial state A in which the gas is stored in hot chamber 3. During this step, the gas passes from cold chamber 5 to hot chamber 3 via regenerator 9. In the regenerator, the heat extracted during the isochoric cooling (step B to C) is given back to the gas as it passes through the regenerator for the second time (step D to A). Thus, the gas heats up before coming in contact with exchanger 7. It should be noted that, preferably, in known engines, chambers 3 and 5 alternately almost totally empty during the cycle.

In engine cycle, the mechanical work extracted during the expansion between steps A and B is partly used for the isothermal compression (steps C to D). The regenerator enables for the heat extracted during the passing from state B to state C to be distributed to the gas during the passing from state D to state A and avoids heat losses. Indeed, the regenerator operates as a counterflow heat exchanger: when a hot gas passes in a cold regenerator, it cools down while heating up the regenerator and, conversely, a cold gas crossing the hot regenerator heats up while cooling down the regenerator. To perform its function, the regenerator must be made of materials which are poor heat conductors in the gas flow direction, for example, insulating materials.

Engines which are desired to be reversible, that is, capable of being used in engine cycle or in heat pump cycle, are considered herein. It should be noted that this definition of reversibility differs from the current definition, for which a reversible engine is an engine with cold and hot sources which may be inverted. A problem linked to current Stirling engines is that, when they have a good engine cycle efficiency, they will have a low heat pump cycle efficiency, and conversely.

Low efficiencies in the reversible use of such engines or in their use over a wide operating range originate from the different losses occurring therein and, especially, from temperature differences in heat exchanges. Another source of irreversible losses in Stirling engines and in any engine implementing theoretically isothermal compressions and expansions is that real systems are far from being capable of enabling such iso-thermal compressions and expansions.

### SUMMARY OF THE INVENTION

An object of an embodiment of the present invention is to provide a thermodynamic engine having a cycle involving almost ideally isothermal compressions and/or expansions.

An object of an embodiment of the present invention is to provide a thermodynamic engine with low losses and a high efficiency over a wide operating range.

Another object of an embodiment of the present invention is to provide a reversible thermodynamic engine.

Another object of an embodiment of the present invention is to provide an optimized heat exchanger.

Thus, an embodiment of the present invention provides a thermodynamic engine intended to operate with a minimum cycle time, comprising at least one compression/expansion and heat exchange chamber, this chamber being longitudinally delimited by first and second walls, mobile with respect to each other, characterized in that said chamber is divided by partitions extending longitudinally from each of the first and second walls, the partitions being interleaved, the distance between partitions extending from a same wall being such that the ratio between the square of this distance and the minimum cycle time is smaller than the average thermal diffusivity of the gas contained in the chamber.

According to an embodiment of the present invention, the distance between partitions extending from a same wall is such that said ratio is smaller than half the average diffusivity of the gas contained in the chamber.

According to an embodiment of the present invention, the first wall is gas-tight and is intended to be placed in contact with a heat source and the second wall is capable of letting gas flow to the outside of the compression/expansion chamber.

According to an embodiment of the present invention, the distance between partitions extending from a same wall is shorter than 2 mm, the gas contained in the compression/expansion chamber being hydrogen or helium.

According to an embodiment of the present invention, the distance between partitions extending from a same wall is shorter than 0.5 mm.

According to an embodiment of the present invention, the chamber is cylindrical and the partitions have, in cross-section along a direction perpendicular to the chamber length, a spiral shape.

According to an embodiment of the present invention, the assembly formed of a wall and of the associated partitions is formed of a winding of a wide strip and of at least one separation strip.

According to an embodiment of the present invention, the separation strip is a wavy strip.

According to an embodiment of the present invention, the separation strip is formed of two corrugated strips placed in opposition, with overlapping corrugations.

According to an embodiment of the present invention, the chamber is cylindrical and the partitions form, in cross-section along a direction perpendicular to the chamber length, an assembly of parallel wavy portions.

According to an embodiment of the present invention, the chamber is cylindrical and the partitions form, in cross-section along a direction perpendicular to the chamber length, an assembly of parallel planar portions.

According to an embodiment of the present invention, at least one wall forms the end of a controllable piston.

According to an embodiment of the present invention, the partitions are made of a thermally conductive ceramic, for example, silicon carbide or aluminum nitride, copper, aluminum, or steel.

### BRIEF DESCRIPTION OF THE DRAWINGS

The foregoing and other objects, features, and advantages of the present invention will be discussed in detail in the following non-limiting description of specific embodiments in connection with the accompanying drawings:

FIG. 1, previously described, is a generic diagram of a Stirling engine;

FIGS. 2A to 2D, previously described, illustrate steps of a Stirling engine cycle;

FIGS. 3A to 3C are cross-section views of a portion of an engine according to an embodiment of the present invention, in several configurations;

FIGS. 4 and 5 are two perspective views of portions of engines according to an embodiment of the present invention;

FIG. 6 illustrates a possible embodiment of a half-exchanger according to an embodiment of the present invention;

FIG. 7 is a cross-section view of a Stirling engine according to an embodiment of the present invention;

FIGS. 8A and 8B illustrate another possible embodiment of a half-exchanger according to an embodiment of the present invention; and

FIG. 9 is a curve illustrating an advantage of an engine according to an embodiment of the present invention.

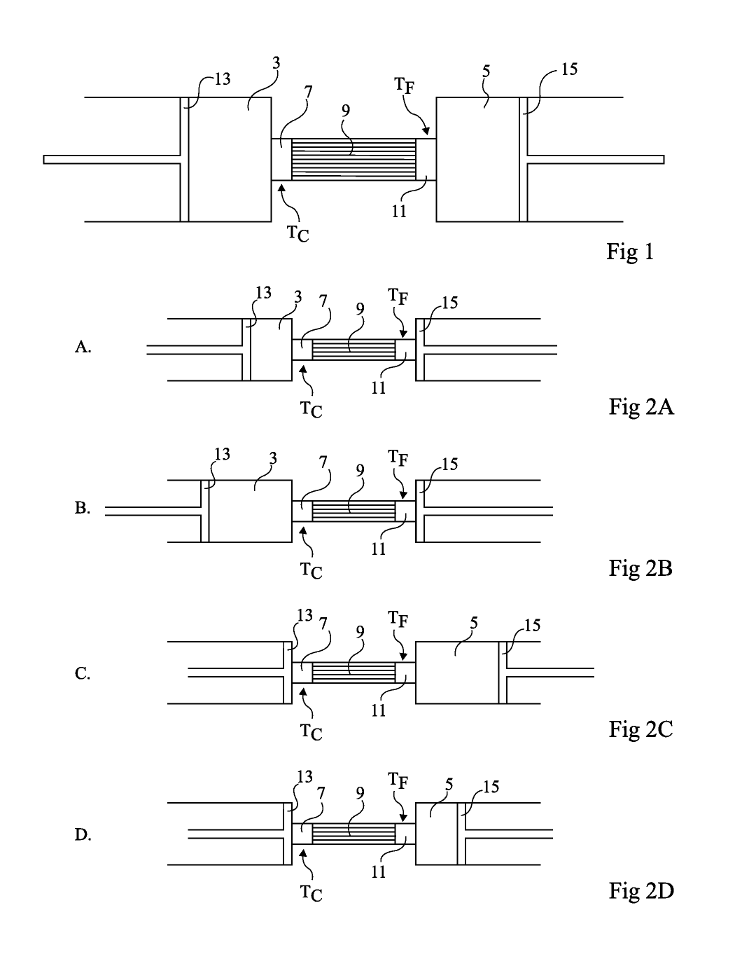

For clarity, the same elements have been designated with the same reference numerals in the different drawings and, further, the various drawings are not to scale.

### DETAILED DESCRIPTION

An embodiment of the present invention first provides directly placing heat exchangers in compression and expansion chambers. It further provides forming compression and expansion chambers in which the exchangers comprise many portions forming partitions in the chambers. Such partitions extend from two opposite walls of the chambers and interleave when the chamber volume decreases.

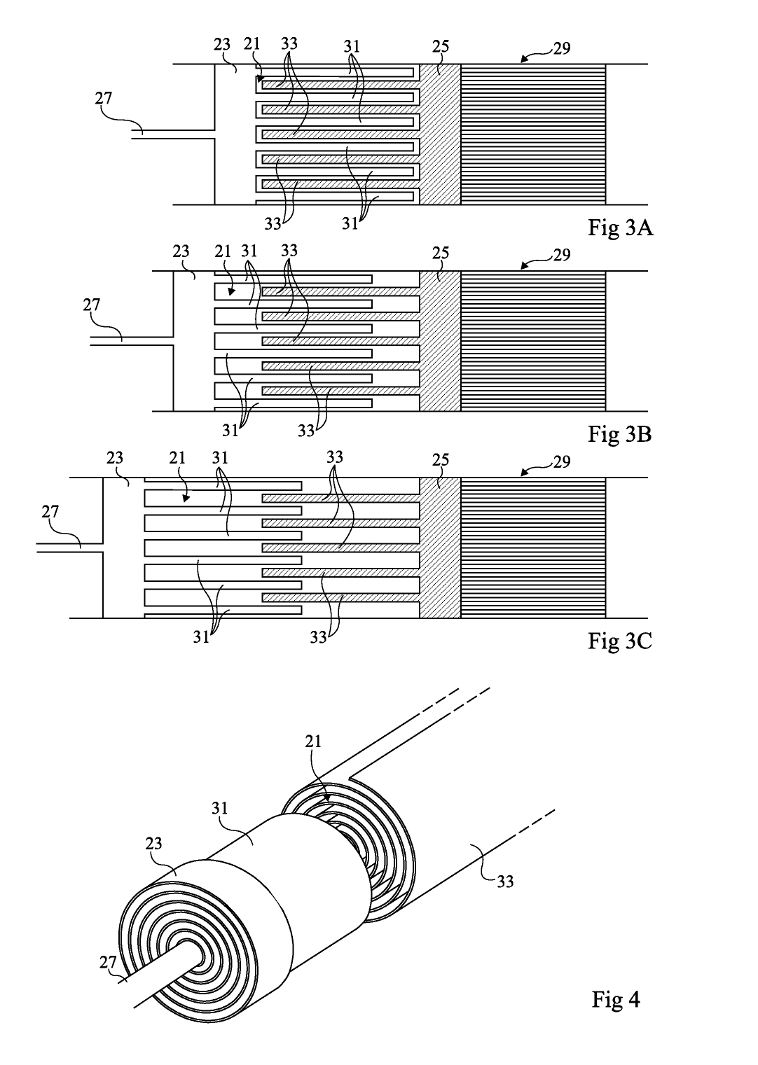

FIGS. 3A to 3C illustrate, in longitudinal cross-section view, a compression or expansion chamber such as described hereabove forming, for example, a portion of a Stirling engine. These drawings illustrate different states in an isothermal expansion.

In FIG. 3A, a chamber 21 is formed in a cylinder and is delimited by two walls 23 and 25 mobile with respect to each other in the cylinder. The shown example considers a mobile wall 23 associated with a piston axis 27, and a fixed wall 25, fixed with respect to a regenerator 29 (not detailed). It should be understood that walls 23 and 25 may be mobile with respect to each other in another way. Wall 23 is tight and wall 25 is permeable to gases, for example, by being provided with many perforations.

Partitions 31 extend in chamber 21 from wall 23 and partitions 33 extend in chamber 21 from wall 25. Partitions 31 and 33 extend in the longitudinal direction of the cylinder and are arranged in alternation in cross-section view. Partitions 31 and 33 form two half-exchangers.

In the state of FIG. 3A, the ends of partitions 31 are close to wall 25 and the ends of partitions 33 are close to wall 23. The volume of chamber 21 is thus minimum. A hot source (or a cold source in the opposite case of a compression) is connected to one of walls 23 or 25, here wall 23, by adapted means, not shown. Wall 23 may be in direct contact with the hot source or be in contact therewith via a hot or cold fluid flow.

FIG. 3C illustrates the device when the volume of chamber 21 is maximum, that is, piston 23-27 and partitions 31 are as distant from wall 25 as possible. In the drawing, the free ends of partitions 31 and 33 are shown opposite to one another in chamber 21. It may also be provided for the ends of partitions 31 and 33 to be slightly distant from one another.

FIG. 3B illustrates the device in a position intermediary between the positions of FIGS. 3A and 3C.

The interleaved structure of the two half-exchangers enables, at any moment, for each molecule of the gas present in chamber 21 to be relatively close to a partition 31 or 33. Thus, in the case of an expansion where partitions 31 and 33 are hot, all the gas molecules are close to a hot partition during the expansion, which enables to avoid the forming of gas pockets having a temperature lower than that of the hot source, and thus ensures an isothermal expansion. The structure discussed herein thus enables to improve the ability of the assembly to conduct heat from the heat source to the gas of chamber 21 and to attenuate losses due to temperatures differences between the heat source and the gas.

To provide good exchanges between the heat source and the gas and avoid losses due to a dead volume in the chamber, the inventor provides for the partition to be arranged so that:

d²/T<D,

d being the distance between two successive partitions 31 or 33 of a same half-exchanger;
T being the minimum cycle time of the thermodynamic engine (that is, the time of a minimum reciprocating motion in the case of the Stirling engine described in relation with FIGS. 2A to 2D); and
D being the average diffusivity over a cycle of the gas in the chamber.

Preferably, ratio d²/T will be smaller than half thermal diffusivity D of the gas. This enables to maintain a substantially uniform gas temperature in chamber 21, substantially equal to the temperature of the heat source, and thus to perform almost ideally isothermal compressions and expansions. The application of the above inequation enables to use heat transfers by thermal diffusion from the partitions extending from the compression/expansion chamber to the gas. Thus, heat transfers are mainly performed by diffusion, possible turbulence phenomena having little or no influence on the transfers.

Partitions 31 and 33 may be made of a thermally conductive material, for example, of a ceramic such as silicon carbide, aluminum nitride, or also copper or aluminum. In this case, it should be understood that, in the position of FIG. 3A, partitions 33 are heated by partitions 31 via the gas. During the expansion, partitions 33 distribute the stored heat to the gas, and especially to the gas located close to wall 25. For a proper operation, it should be understood that the engine cycle time must be sufficiently long for heat exchanges between partitions 31 and 33 and the gas to have time to occur.

The inventor has noted that partitions 33 may also be made of poorly conductive materials, without for all this modifying the isothermal character of the expansions/compressions. Similarly, partitions 31 may be formed of poorly conductive materials, except at their ends connected to wall 23. Indeed, in this case, in the state of FIG. 3A, the heat is transmitted from wall 23 to the adjacent areas of partitions 31 and then, via the gas, to the free ends of partitions 33. During the expansion, the free ends of partitions 33 are successively opposite to the different portions of partitions 31 and the heat thus passes from the end of partitions 33 to partitions 31, and then again from partitions 31 to partitions 33. When the volume of chamber 21 decreases, the heat also passes between partitions 31 and partitions 33 via the gas. Thus, during a cycle, partitions 31 and 33 are entirely hot and transmit their heat to the gas.

In the case where a poorly conductive material is used for partitions 31 and 33, the following relation must be satisfied:

$$\frac{{λ}_{gas} \cdot {a}^{2}}{{d}^{′}} > e . {λ}_{partition}$$

λ_{gas} being the thermal conductivity of the gas;
λₚₐᵣₜᵢₜᵢₒₙ being the thermal conductivity of the material forming partitions 31 and 33;
a being the amplitude of the relative motion of partitions 31 and 33;
d′ being the distance separating two successive partitions 31 and 33 belonging to two different half-exchangers; and
e being the average thickness of partitions 31 and 33.

The possible use of poorly conductive materials enables to form partitions 31 and 33 made of many materials, for example, of light materials, of low-cost materials, or other materials well adapted to the forming of such exchangers, for example, steel.

It should be noted that the discussed structure comprising two reciprocating slidingly interleaved half-exchangers may be generalized to form any type of exchanger between a hot (or cold) source and a gas. Indeed, advantage may be taken of the improved heat propagation between half-exchangers, due to their relative motions and their interleaving, to form any type of exchanger, for example, radiators through which a gas flows. The gas may for example enter through one of the walls and come out through the opposite wall.

As an example of numerical values, distance d between partitions 31 and 33 may range between 0.3 and 2 mm and the partitions may have a thickness ranging between 0.1 and 0.6 mm, if the gas in chamber 21 is hydrogen or helium. The engine cylinder may have a diameter ranging between 15 and 20 cm and wall 23 may move by approximately 3 cm within the cylinder. With such dimensions, a cycle time ranging between 0.02 and 0.5 second enables to comply with inequation d²/T<D.

It should also be noted that losses in the exchangers are further attenuated if partitions 31, 33 are slightly thinner at their free ends than at their holding ends (towards walls 23 and 25).

FIG. 4 is a perspective view of portions of an engine capable of performing an isothermal compression or expansion according to an embodiment of the present invention. In this drawing, for simplification, the external cylinder in which the engine elements are moving is not shown. Further, partitions 31 and 33 have been shown as distant from one another to make the understanding easier. In practice, the partitions are interleaved.

In this embodiment, partitions 31 and 33 have, in cross-section in a plane perpendicular to the chamber length, spiral shapes. A first spiral forms partitions 31 and a second spiral forms partitions 33. Spirals 31 and 33 are provided to interleave as the volume of chamber 21 decreases.

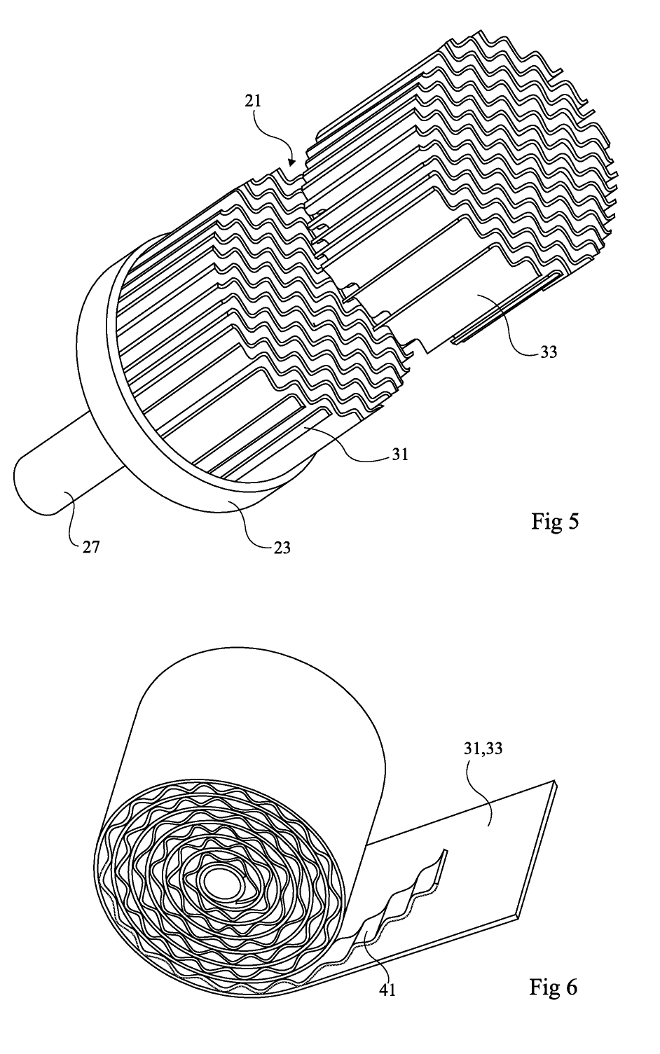

FIG. 5 is a perspective view of portions of an engine capable of performing an isothermal compression or expansion according to another embodiment of the present invention.

In this embodiment, partitions 31 and 33 are formed, in cross-section along a direction perpendicular to the chamber length, of many parallel plates separated by a pitch. In the illustrated example, although the plates are wavy to improve their hold, it should be noted that these plates may also be planar. Wavy portions 31 are shifted from wavy portions 33, for example, by a half-step, for these portions to interleave without touching as the volume of chamber 21 varies.

Wall 23, which is a wall external to the system, must be gas-tight. Thus, in wall 23, portions 31, whether they have a spiral shape or the shape of parallel plates, are separated by a material ensuring the gas tightness and/or are attached to a piston body. Conversely, the walls internal to the system, for example, wall 25 of FIGS. 3A to 3C, play two roles: enabling the holding of portions 33 and letting through the gas, for example, towards a regenerator. Thus, they may for example be perforated.

FIG. 6 illustrates a possible embodiment of a structure for holding a spiral-shaped partition.

To hold a spiral-shaped partition 31 or 33 such as that in FIG. 4, spacing or mechanical hold means may be placed between the different coils, on the side where the spiral is attached to the wall. In the example of FIG. 6, such means are formed of a strip 41 which is wound at the same time as the strip of thermally conductive or insulating material and which is thus inside of the winding. In this example, strip 41 is wavy and the height of the waves sets the pitch between the coils of spiral 31, 33. It should be noted that the structure of FIG. 6 may also be used to form walls 25, strip 41 being then used to hold wall 25 letting through the gas towards the regenerator. In the case where strip 41 is located between conductive spirals, this strip will preferably have a high conductivity, for example, by being made of an aluminum alloy.

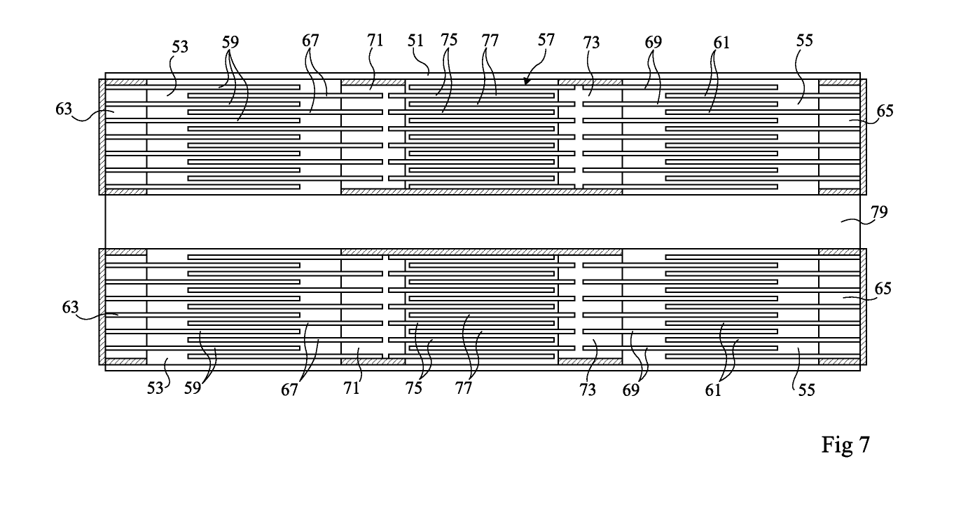

FIG. 7 is a detailed cross-section view of the body of a Stirling engine implementing an embodiment of the present invention.

The engine is formed in a cylinder 51 and comprises a first chamber 53 and a second chamber 55 separated by a regenerator 57. An exchanger, formed of two half-exchangers such as discussed hereabove, is formed in each of chambers 53 and 55. A first half-exchanger 59, respectively 61, located in chamber 53, respectively 55, extends from a wall external to engine 63, respectively 65. A second half-exchanger 67, respectively 69, located in chamber 53, respectively 55, extends from a wall internal to engine 71, respectively 73, which delimits the position of the regenerator.

In the shown example, regenerator 51 is formed of partitions 75, 77 which respectively extend from walls 71 and 73. Partitions 75 and 77 are shown in interleaved configuration, for example, with a shape identical to that of portions 59 and 67 or 61 and 69. Partitions 75 and 77 are preferably made of a material which is a poor thermal conductor but has good proper-ties of thermal exchange with the gas, that is, a sufficient thermal effusivity. For example, partitions 75 and 77 may be made of polycarbonate. Guides parallel to the gas flow may be added in the regenerator to ensure for the gas transiting therethrough to follow the same path in both displacement directions. It should be noted that the regenerator structure de-scribed herein is an example only and that any known regenerator type may be used with the exchangers of FIGS. 3A to 3C.

In the shown example, a central shaft 79 is located at the core of cylinder 51. This shaft contains elements enabling to position the different elements of the thermodynamic engine with respect to one another. Partitions 59, 67, 61, and 69, or even partitions 75 and 77, may be spiral-shaped around shaft 79. Elements providing the tightness, the thermal insulation, the mechanical hold, and/or the displacement of the different walls 63, 65, 71, and 73 in cylinder 51 are shown in FIG. 7 by hatched portions.

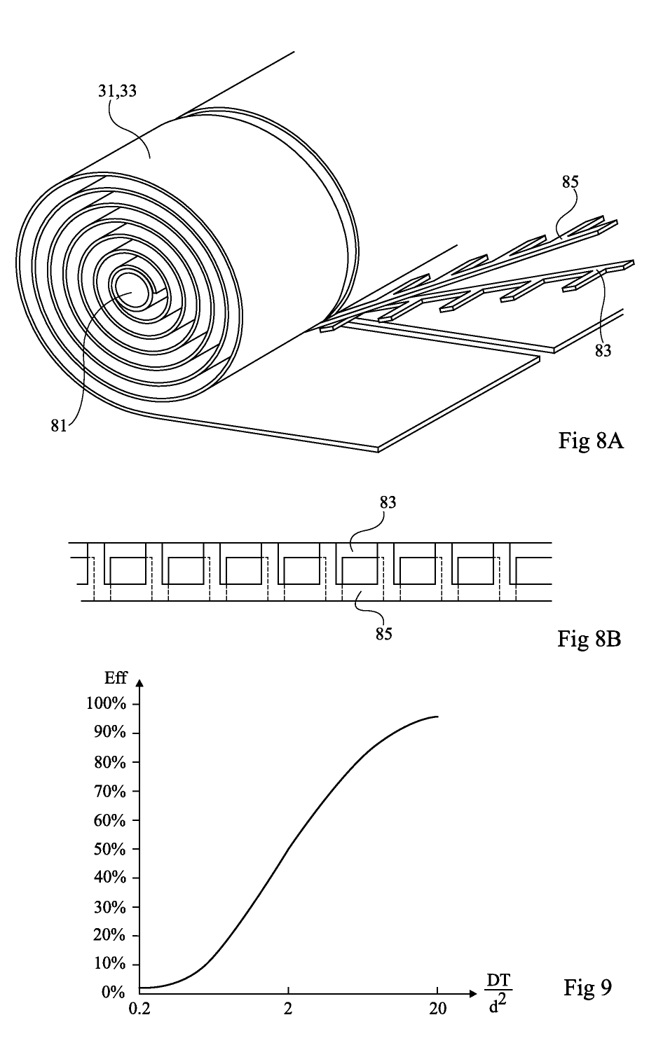

FIGS. 8A and 8B illustrate another possible embodiment of a structure for holding a spiral-shaped partition.

In FIG. 8A, a layer 31, 33, thermally conductive or not, is wound around an axis 81. During the winding of layer 31, 33 on axis 81, two strips 83 and 85 having a corrugated shape in top view are also wound between two spirals of layer 31, 33. The two strips 83 and 85 are positioned on each other so that the corrugations are in opposition and slightly superposed to one another. It should be noted that the arrangement of strips 83 and 85 on material 31, 33 is shown at the end of the winding only in FIG. 8A.

FIG. 8B further illustrates the arrangement of strips 83 and 85 with respect to each other and the superposition of portions of the corrugations of these strips. The superposition of strips 83 and 85 enables to hold material 31-33 while enabling the gas to flow between the different spirals of the structure of FIG. 8A. Thus, the structure of FIGS. 8A and 8B may have the same function as that in FIG. 6.

FIG. 9 is a curve illustrating the corrective effect (Eff) associated with the use of a device according to an embodiment with respect to the use of a conventional device (partition-less chamber), in proportion, in an expansion or a compression, according to ratio D.T/d². Given that ratio d²/T must be lower than diffusivity D of the gas, this means that ratio D.T/d² must be greater than 1. In this curve, a 0% corrective effect means that losses due to temperature differences in the chamber during compressions and expansions are not attenuated, and a 100% corrective effect means that such losses are nonexistent.

The use of the structures described herein provides a corrective effect of approximately 50% when ratio D.T/d² is on the order of 2 and of approximately 90% when this ratio is on the order of 10. Thus, the present invention enables to strongly decrease losses due to temperature differences during compressions and expansions and thus to perform isothermal transformations.

The use of interleaved exchangers enables to obtain Stirling engines capable of having an efficiency of 85% of the maximum Carnot efficiency over significant operating ranges. It is also possible to manufacture engines of lower volume for an efficiency similar to that of current engines. Further, the efficiency is stable over a significant hot and cold temperature range, with no modification of the engine geometry. The efficiency also remains good over significant power ranges, by varying the cycle time. A good efficiency is also obtained in case of a reversible operation.

Specific embodiments of the present invention have been described. Various alterations and modifications will occur to those skilled in the art. In particular, it should be noted that the different advantages of the present invention have been described with respect to its application to reversible Stirling engines. It should be noted that the forming of conductive partitions in compression or expansion chambers to make such compressions or expansions isothermal may be applied to any engine carrying out such transformations, for example, Ericsson engines. The present invention may also be applied to any type of compressor or air injection machine with a linear piston.

It should also be noted that the present invention applies to cylindrical compression and/or expansion chambers having any shape, be it rotational or not.

1. A thermodynamic engine intended to operate with a minimum cycle time (T), comprising at least one compression/expansion and heat exchange chamber (21), said chamber being longitudinally delimited by first and second walls, mobile with respect to each other (23, 25), characterized in that said chamber is divided by partitions (31, 33) extending longitudinally from each of the first and second walls, the partitions being interleaved, the distance between partitions extending from a same wall being such that the ratio between the square of this distance (d) and said minimum cycle time (T) is smaller than the average diffusivity (D) of the gas contained in the chamber (d²/T<D).

2. The engine of claim 1, wherein the distance between partitions extending from a same wall is such that said ratio is smaller than half the average diffusivity (D) of the gas contained in the chamber (21).

3. The engine of claim 1 or 2, in which the first wall (23) is gas-tight and is intended to be placed in contact with a heat source, and the second wall is capable of letting a gas flow to the outside of the compression/expansion chamber.

4. The engine of any of claims 1 to 3, wherein the distance between partitions extending from a same wall is shorter than 2 mm, the engine having a cycle time greater than 0.02 second, the gas contained in the compression/expansion chamber being hydrogen or helium.

5. The engine of claim 4, wherein the distance between partitions extending from a same wall is shorter than 0.5 mm.

6. The engine of any of claims 1 to 5, wherein the chamber is cylindrical and wherein the partitions (31, 33) have, in cross-section along a direction perpendicular to the chamber length, a spiral shape.

7. The engine of claim 6, wherein the assembly formed of a wall and of the associated partitions is formed of a winding of a wide strip and of at least one separation strip.

8. The engine of claim 7, wherein the separation strip is a wavy strip (41).

9. The engine of claim 7, wherein the separation strip is formed of two corrugated strips (83, 85) placed in opposition, with overlapping corrugations.

10. The engine of any of claims 1 to 5, wherein the chamber is cylindrical and wherein the partitions (31, 33) form, in cross-section along a direction perpendicular to the chamber length, an assembly of parallel wavy portions.

11. The engine of any of claims 1 to 5, wherein the chamber is cylindrical and wherein the partitions (31, 33) form, in cross-section along a direction perpendicular to the chamber length, an assembly of parallel planar portions.

12. The engine of any of claims 1 to 11, wherein at least one wall (23, 25) forms the end of a controllable piston.

13. The engine of any of claims 1 to 12, wherein the partitions (31, 33) are made of a thermally conductive ceramic, for example, silicon carbide or aluminum nitride, copper, aluminum, or steel.
